(19) United States
(12) Patent Application Publication
(10) Pub. No.: US 2026/0335811 A1
(43) Pub. Date: Oct. 29, 2026

(54) CARBON DIOXIDE CAPTURE DEVICE AND METHOD FOR PROTECTING ABSORPTION SECTION PACKING

(71) Applicant: MITSUBISHI HEAVY INDUSTRIES, LTD., Tokyo (JP)

(72) Inventors: Masaki Onishi, Tokyo (JP); Tetsu Ushiku, Tokyo (JP); Osamu Miyamoto, Tokyo (JP); Tatsuya Tsujiuchi, Tokyo (JP); Miku Iwamoto, Tokyo (JP)

(73) Assignee: MITSUBISHI HEAVY INDUSTRIES, LTD., Tokyo (JP)

(21) Appl. No.: 19/187,271

(22) Filed: Apr. 23, 2025

(51) Int. Cl. B01D 53/14; B01D 53/18

(52) U.S. Cl. CPC B01D 53/1475; B01D 53/1412; B01D 53/1425; B01D 53/18; B01D 2257/504; B01D 2258/0283

(57) ABSTRACT

A carbon dioxide capture device includes a cooling tower cooling exhaust gas, an absorption tower absorbing carbon dioxide contained in the exhaust gas into an absorbing liquid to remove the carbon dioxide, and a regeneration tower separating the carbon dioxide from the absorbing liquid discharged from the absorption tower to regenerate the absorbing liquid, in which the absorption tower includes a resin-made absorption section packing bringing the absorbing liquid and the exhaust gas into gas-liquid contact, a lean absorbing liquid line supplying the absorbing liquid to the absorption tower, a heat exchanger provided in the lean absorbing liquid line and cools the absorbing liquid, and an absorption tower control unit lowering the set temperature of the heat exchanger in the lean absorbing liquid line when the temperature of the absorption section packing a limit temperature or higher, which corresponds to the heat resistance temperature of the absorption section packing.

### BACKGROUND OF THE INVENTION

### Field of the Invention

The present disclosure relates to a carbon dioxide capture device and a method for protecting an absorption section packing.

### Description of Related Art

A carbon dioxide capture device that removes and captures carbon dioxide from exhaust gas includes a cooling tower that cools the exhaust gas, an absorption tower that absorbs the carbon dioxide contained in the cooled exhaust gas into an absorbing liquid to capture the carbon dioxide, and a regeneration tower that separates and regenerates the carbon dioxide from the absorbing liquid that has absorbed the carbon dioxide. The absorption tower includes a gas-liquid contact packing and a nozzle for spraying the absorbing liquid onto the gas-liquid contact packing, which are provided inside. The cooling tower includes a gas-liquid contact packing and a nozzle for spraying cooling water onto the gas-liquid contact packing, which are provided inside. Generally, the gas-liquid contact packing is formed of a metal material. However, since the metal-made gas-liquid contact packing is heavy, a structure supporting the gas-liquid contact packing needs to be increased in size. Therefore, for example, Patent Document 1 and Patent Document 2 describe technologies of using a resin material that is lighter than a metal material for the gas-liquid contact packing.

### PATENT DOCUMENTS

[Patent Document 1] Japanese Patent No. 5794775
[Patent Document 2] U.S. Pat. No. 4,950,430

### SUMMARY OF THE INVENTION

However, a resin-made gas-liquid contact packing has lower heat resistance and a greater linear expansion coefficient compared with a metal-made gas-liquid contact packing. Therefore, in the case where high-temperature exhaust gas is introduced or in the case where the temperature rises due to heat generated during the absorption of carbon dioxide by the absorbing liquid, deformation or damage may occur. In addition, melting or damage may occur in welding work such as maintenance.

The present disclosure provides a carbon dioxide capture device and a method for protecting an absorption section packing that can prevent high-temperature exhaust gas exceeding the heat resistance temperature from flowing into a resin-made absorption section packing.

According to an aspect of the present disclosure, there is provided a carbon dioxide capture device including a cooling tower that cools exhaust gas, an absorption tower that absorbs carbon dioxide contained in the exhaust gas cooled in the cooling tower into an absorbing liquid and removes the carbon dioxide, and a regeneration tower that separates the carbon dioxide from the absorbing liquid discharged from the absorption tower to regenerate the absorbing liquid, in which the absorption tower includes an absorption section packing made of a resin that brings the absorbing liquid and the exhaust gas into gas-liquid contact, and an absorption tower control unit that performs control to reduce the temperature of the absorption section packing in a case where the temperature of the absorption section packing is equal to or higher than a limit temperature according to the heat resistance temperature of the absorption section packing.

According to one aspect of the present disclosure, there is provided a method for protecting an absorption section packing in a carbon dioxide capture device including a cooling tower that cools exhaust gas, an absorption tower that absorbs and removes carbon dioxide contained in the exhaust gas cooled in the cooling tower using an absorbing liquid, and a regeneration tower that separates the carbon dioxide from the absorbing liquid discharged from the absorption tower to regenerate the absorbing liquid, the method including a step of performing control to reduce a temperature of the absorption section packing in a case where a temperature of a resin-made absorption section packing in which the absorbing liquid and the exhaust gas are brought into gas-liquid contact is equal to or higher than a limit temperature according to the heat resistance temperature of the absorption section packing.

According to the above-mentioned aspects, it is possible to prevent high-temperature exhaust gas exceeding the heat resistance temperature from flowing into the resin-made absorption section packing.

### BRIEF DESCRIPTION OF THE DRAWINGS

FIG. 1 is a schematic diagram showing an overall configuration of a carbon dioxide capture system according to a first embodiment of the present disclosure.

FIG. 2 is a first schematic diagram showing an example of the configuration of a cooling tower according to the first embodiment of the present disclosure.

FIG. 3 is a second schematic diagram showing an example of a configuration of the cooling tower according to the first embodiment of the present disclosure.

FIG. 4 is a third schematic diagram showing an example of a configuration of the cooling tower according to the first embodiment of the present disclosure.

FIG. 5 is a fourth schematic diagram showing an example of a configuration of the cooling tower according to the first embodiment of the present disclosure.

FIG. 6 is a flowchart showing an example of processing of a cooling tower control unit according to the first embodiment of the present disclosure.

FIG. 7 is a first schematic diagram showing an example of the configuration of a carbon dioxide capture device according to a second embodiment of the present disclosure.

FIG. 8 is a second schematic diagram showing an example of a configuration of the carbon dioxide capture device according to the second embodiment of the present disclosure.

FIG. 9 is a schematic diagram showing an example of a configuration of the absorption tower according to the third embodiment of the present disclosure.

FIG. 10 is a flowchart showing an example of processing of an absorption tower control unit according to the third embodiment of the present disclosure.

FIG. 11 is a schematic diagram showing an example of a configuration of the absorption tower according to the modification example 1 of the third embodiment of the present disclosure.

FIG. 12 is a schematic diagram showing an example of the configuration of an absorption tower according to a modification example 2 of the third embodiment of the present disclosure.

FIG. 13 is a diagram showing an example of a temperature profile of an absorption tower packing.

FIG. 14 is a schematic diagram showing an example of the configuration of an absorption tower according to a modification example 3 of the third embodiment of the present disclosure.

FIG. 15 is a schematic block diagram showing the configuration of a computer of a control unit according to at least one embodiment.

### DETAILED DESCRIPTION OF THE INVENTION

### First Embodiment

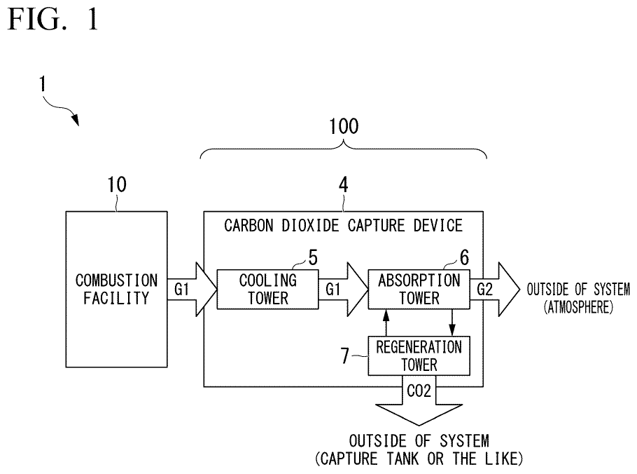

Hereinafter, a carbon dioxide capture system according to a first embodiment of the present disclosure will be described in detail with reference to FIGS. 1 to 6.

### Overall Configuration of Carbon Dioxide Capture System

FIG. 1 is a schematic diagram showing an overall configuration of the carbon dioxide capture system according to the first embodiment of the present disclosure. A carbon dioxide capture system 100 captures carbon dioxide from exhaust gas G1 discharged from a combustion facility 10 of a plant 1. The combustion facility 10 combusts fuel and air to discharge the exhaust gas G1 and may be, for example, any facility such as a boiler, an incinerator, or a gas turbine. The carbon dioxide capture system 100 includes a carbon dioxide capture device 4.

The carbon dioxide capture device 4 is provided downstream of the combustion facility 10. The carbon dioxide capture device 4 includes a cooling tower 5, an absorption tower 6, and a regeneration tower 7. The cooling tower 5 cools the exhaust gas G1. The absorption tower 6 removes carbon dioxide contained in the exhaust gas G1 cooled by the cooling tower 5 by absorbing the carbon dioxide into an absorbing liquid. The absorption tower 6 discharges purified gas G2, from which the carbon dioxide has been removed, to the outside of the system (atmosphere) and discharges the absorbing liquid that has absorbed the carbon dioxide to the regeneration tower 7. The regeneration tower 7 separates the carbon dioxide from the absorbing liquid discharged from the absorption tower 6 to regenerate the absorbing liquid. The regeneration tower 7 returns the regenerated absorbing liquid to the absorption tower 6 and discharges the separated carbon dioxide to the outside of the system. The carbon dioxide discharged from the regeneration tower 7 is stored in a capture tank or the like and used in another system or the like.

Although FIG. 1 shows an example in which the exhaust gas G1 discharged from the combustion facility 10 is directly introduced into the carbon dioxide capture device 4, the present disclosure is not limited to this device configuration. The carbon dioxide capture system 100 may be provided, as necessary, with a pretreatment facility for the exhaust gas G1, such as a dust collection device that removes soot and dust contained in the exhaust gas G1 or a desulfurization device that removes sulfur oxides (SOx) contained in the exhaust gas G1, between the combustion facility 10 and the carbon dioxide capture device 4.

### Configuration Example 1 of Cooling Tower

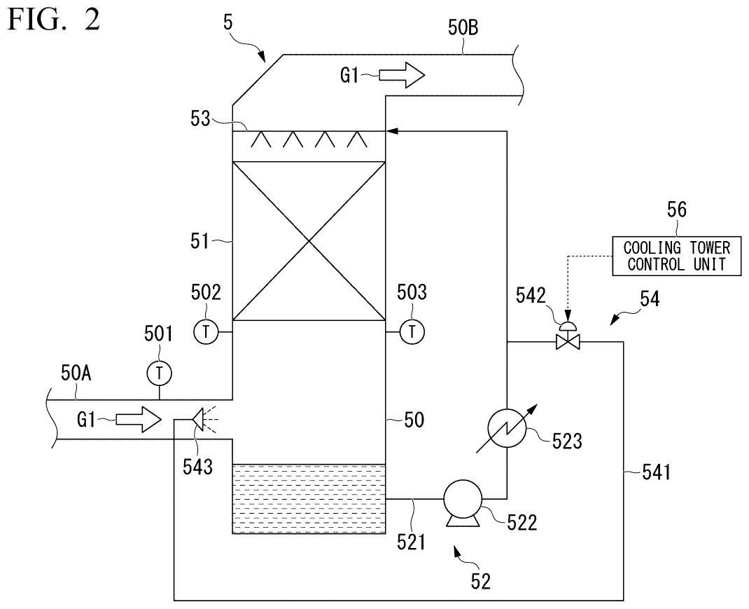

FIG. 2 is a schematic diagram showing an example of a configuration of the cooling tower according to the first embodiment of the present disclosure. As shown in FIG. 2, the cooling tower 5 includes a main body section 50, a cooling tower packing 51, a condensed water circulation section 52, a condensed water distribution section 53, a cooling section 54, and a cooling tower control unit 56.

The main body section 50 is a hollow container that extends in a vertical direction, and the exhaust gas G1 flows in the vertical direction through an inside of the main body section 50. An exhaust gas introduction flow passage 50A through which the exhaust gas G1 treated by a dust collection device 2 and a desulfurization device 3 is introduced into the inside of the main body section 50 is connected to a lower part of the main body section 50 (to an upstream side in a flow direction of the exhaust gas G1). An exhaust gas discharge flow passage 50B through which the exhaust gas G1 cooled inside the main body section 50 is discharged to the absorption tower 6 is connected to an upper part of the main body section 50 (to a downstream side in the flow direction of the exhaust gas G1). A blower (not shown) is provided between the cooling tower 5 and the absorption tower 6 (on a downstream side of the exhaust gas discharge flow passage 50B), and the exhaust gas is drawn into the absorption tower 6 by the blower. Condensed water generated by cooling moisture contained in the exhaust gas G1 is stored in the lower part of the main body section 50.

The cooling tower packing 51 is provided inside the main body section 50. The cooling tower packing 51 is formed of a resin material.

The condensed water circulation section 52 circulates the condensed water stored in the lower part of the main body section 50 to the upper part of the main body section 50 through a condensed water circulation flow passage 521 by pumping up the condensed water with a pump 522. The condensed water circulation flow passage 521 is provided with a heat exchanger 523 that cools the condensed water pumped up by the pump 522 to a predetermined temperature. A lower part of the condensed water circulation flow passage 521 is an upstream side in a flow direction of the condensed water, and an upper part thereof is a downstream side in the flow direction of the condensed water.

The condensed water distribution section 53 is connected to the condensed water circulation flow passage 521 at the upper part of the main body section 50. The condensed water distribution section 53 is disposed above the cooling tower packing 51 and supplies the condensed water cooled by the condensed water circulation section 52 to the cooling tower packing 51. In this case, the condensed water supplied from the condensed water distribution section 53 flows downward from above the cooling tower packing 51. The exhaust gas G1 flowing from the lower part to the upper part of the main body section 50 is cooled by coming into gas-liquid contact with the condensed water flowing through the cooling tower packing 51.

The cooling section 54 includes a cooling water distribution section 543 that supplies cooling water for cooling the exhaust gas G1 to an upstream side of the cooling tower packing 51 in the flow direction of the exhaust gas G1. In the example of FIG. 2, the cooling water distribution section 543 is provided inside the exhaust gas introduction flow passage 50A and supplies the cooling water into the exhaust gas introduction flow passage 50A.

With such a configuration, the cooling section 54 can lower the temperature of the exhaust gas G1 with the cooling water in the exhaust gas introduction flow passage 50A before the exhaust gas G1 flows into the main body section 50 of the cooling tower 5. Consequently, it is possible to prevent high-temperature exhaust gas G1 exceeding the heat resistance temperature from flowing into the resin-made cooling tower packing 51. As a result, the risk of deformation or damage to the cooling tower packing 51 can be reduced, thereby extending the lifespan of the cooling tower packing 51.

The cooling section 54 may supply the cooling water to the cooling water distribution section 543 by introducing the cooling water from outside the system. In addition, as in the example of FIG. 2, the cooling section 54 may use some of the condensed water circulating in the condensed water circulation section 52 as the cooling water. For example, as shown in FIG. 2, the cooling section 54 includes a cooling water flow passage 541 that branches from the condensed water circulation flow passage 521 at a downstream side of the heat exchanger 523 and through which some of the condensed water cooled by the heat exchanger 523 is introduced into the cooling water distribution section 543 as the cooling water. By reusing the condensed water in this way, the cooling section 54 does not need to introduce the cooling water from outside the system, and the operating cost of the cooling tower can be reduced. Additionally, since the condensed water that has been cooled by the heat exchanger 523 of the condensed water circulation section 52 is used as the cooling water, the temperature of the exhaust gas G1 can be effectively lowered.

The cooling section 54 may constantly supply the cooling water from the cooling water distribution section 543 during the operation of the cooling tower 5. In the case where a configuration is employed in which the cooling water is constantly supplied in this way, the cooling tower control unit 56, which will be described below, may be omitted. In addition, the cooling section 54 may supply the cooling water from the cooling water distribution section 543 in the case where the temperature of the exhaust gas G1 becomes high, in accordance with the control of the cooling tower control unit 56. For example, as shown in FIG. 2, the cooling water flow passage 541 is provided with a cooling water control valve 542. The cooling water control valve 542 opens and closes in accordance with the control of the cooling tower control unit 56 to start or stop supplying the cooling water. Further, the cooling water control valve 542 can increase or decrease a supply amount of the cooling water by changing the opening degree in accordance with the control of the cooling tower control unit 56.

In the case where the temperature of the exhaust gas G1 is equal to or higher than a limit temperature corresponding to the heat resistance temperature of the cooling tower packing 51, the cooling tower control unit 56 causes the cooling water distribution section 543 of the cooling section 54 to supply the cooling water. A detailed function (processing example) of the cooling tower control unit 56 will be described below.

Additionally, the main body section 50 is provided with at least one of a first temperature sensor 501 and second temperature sensors 502 and 503 that measure the temperature of the exhaust gas G1. Although FIG. 2 shows an example in which both the first temperature sensor 501 and the second temperature sensors 502 and 503 are provided, in any of other embodiments, at least only one of the first temperature sensor 501 and the second temperature sensors 502 and 503 need only be provided. In the case where the cooling tower control unit 56 is omitted as described above, neither the first temperature sensor 501 nor the second temperature sensors 502 and 503 need to be installed. The first temperature sensor 501 is provided near an outlet of the exhaust gas introduction flow passage 50A (near an inlet of the main body section 50) and measures the temperature of the exhaust gas G1 to be introduced into the main body section 50. The second temperature sensors 502 and 503 measure the temperature of the exhaust gas G1 to be introduced into the cooling tower packing 51 below the cooling tower packing 51 (on the upstream side in the flow direction of the exhaust gas G1). The second temperature sensors 502 and 503 are provided, for example, below the cooling tower packing 51 at at least two or more different positions in a horizontal direction, as shown in FIG. 2, in consideration of the possibility of temperature variations occurring in the cooling tower packing 51. It is possible to prevent the detection of the temperature rise of the exhaust gas G1 from being omitted even in the case where the temperature of the exhaust gas G1 varies depending on the position in the horizontal direction (temperature variations occur).

### Configuration Example 2 of Cooling Tower

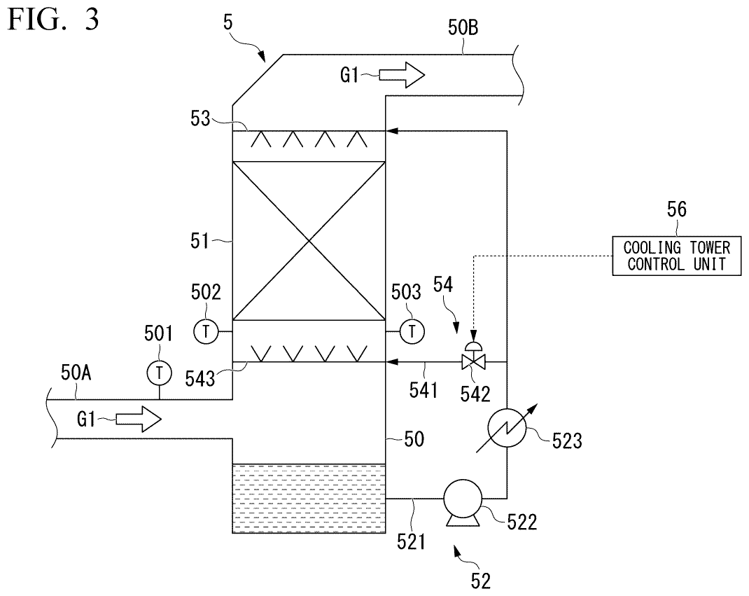

FIG. 3 is a second schematic diagram showing an example of a configuration of the cooling tower according to the first embodiment of the present disclosure. The cooling section 54 may be configured as shown in FIG. 3 instead of the configuration of FIG. 2. The configurations of the cooling water flow passage 541 and the cooling water control valve 542 are the same as those in FIG. 2.

In the example of FIG. 3, the cooling water distribution section 543 is provided below the cooling tower packing 51 inside the main body section 50. The cooling water distribution section 543 supplies the cooling water to the cooling tower packing 51 from below the cooling tower packing 51.

With such a configuration, the cooling section 54 can cool a lower side of the cooling tower packing 51 with the cooling water together with the exhaust gas G1 and can prevent the exhaust gas G1 and the cooling tower packing 51 from being high temperature exceeding the heat resistance temperature of the cooling tower packing 51. Further, the temperature of the exhaust gas G1 is higher toward the lower part of the cooling tower packing 51 (toward the upstream side in the flow direction). Therefore, by supplying the cooling water toward a location where the temperature of the cooling tower packing 51 is likely to rise, the temperatures of the exhaust gas G1 and the cooling tower packing 51 can be appropriately lowered.

### Configuration Example 3 of Cooling Tower

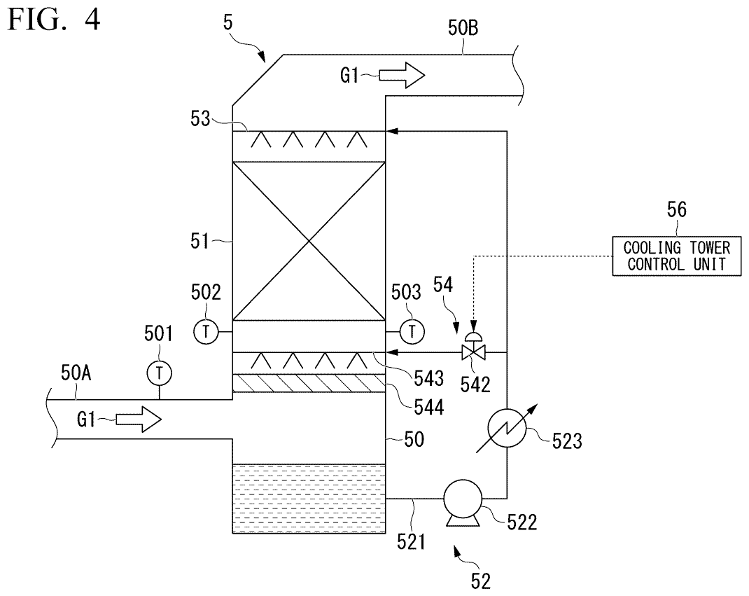

FIG. 4 is a third schematic diagram showing an example of a configuration of the cooling tower according to the first embodiment of the present disclosure. The cooling section 54 may be configured as shown in FIG. 4 instead of the configuration of FIG. 2 or 3. The configurations of the cooling water flow passage 541 and the cooling water control valve 542 are the same as those in FIG. 2.

In the example of FIG. 4, the cooling section 54 further includes a second cooling tower packing 544 disposed below the cooling tower packing 51 and spaced apart from the cooling tower packing 51 inside the main body section 50. The second cooling tower packing 544 has a heat resistance temperature higher than that of the cooling tower packing 51. Specifically, the second cooling tower packing 544 is a metal-made packing having a heat resistance temperature higher than that of the resin-made cooling tower packing 51.

Additionally, the cooling water distribution section 543 is provided between the cooling tower packing 51 and the second cooling tower packing 544 inside the main body section 50 and supplies the cooling water to the second cooling tower packing 544 from above.

With such a configuration, the cooling section 54 can lower the temperature of the exhaust gas G1 with the second cooling tower packing 544 having a higher heat resistance temperature before the exhaust gas G1 flows through the cooling tower packing 51. In addition, by cooling the second cooling tower packing 544 with the cooling water, the temperature of the exhaust gas G1 can be more reliably lowered before the exhaust gas G1 reaches the cooling tower packing 51.

### Configuration Example 4 of Cooling Tower

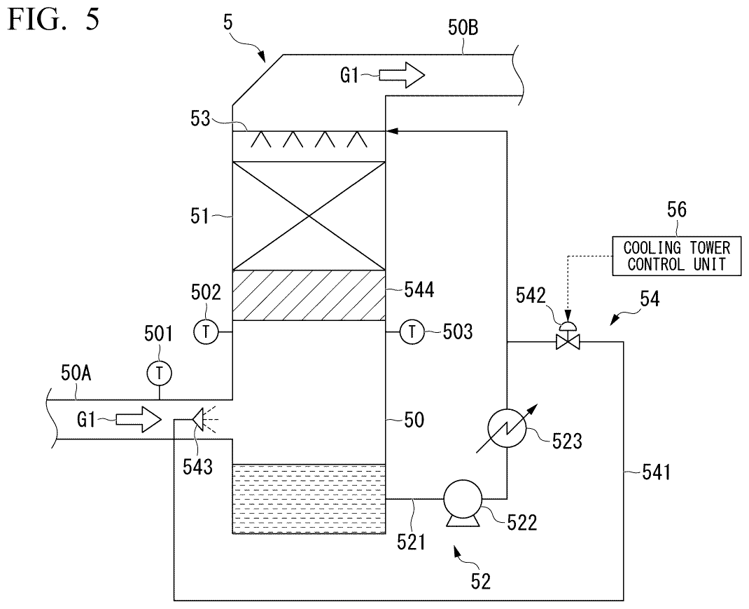

FIG. 5 is a fourth schematic diagram showing an example of a configuration of the cooling tower according to the first embodiment of the present disclosure. The cooling section 54 may be configured as shown in FIG. 5 instead of the configuration of FIG. 4.

In the example of FIG. 5, the second cooling tower packing 544 of the cooling section 54 is attached to a lower end of the cooling tower packing 51. The second cooling tower packing 544 is a metal-made packing having a heat resistance temperature higher than that of the cooling tower packing 51, in the same manner as in the example of FIG. 4.

Additionally, FIG. 5 shows an example in which the cooling water distribution section 543 is provided in the exhaust gas introduction flow passage 50A, in the same manner as in FIG. 2, but the present disclosure is not limited thereto. In another embodiment, the cooling water distribution section 543 may be configured to supply the cooling water to the second cooling tower packing 544 from below the cooling tower packing 51, that is, from below the second cooling tower packing 544, in the same manner as in FIG. 3. The configurations of the cooling water flow passage 541 and the cooling water control valve 542 are the same as those in FIG. 2.

In the same manner as in the example of FIG. 4, the cooling section 54 can lower the temperature of the exhaust gas G1 with the second cooling tower packing 544 having a higher heat resistance temperature before the exhaust gas G1 flows through the cooling tower packing 51. In addition, by cooling the second cooling tower packing 544 with the cooling water, the temperature of the exhaust gas G1 can be more effectively lowered.

In the examples of FIGS. 4 and 5, the second cooling tower packing 544 may have a vertical length shorter than that of the cooling tower packing 51. By doing so, the sum of the weights of the resin-made cooling tower packing 51 and the metal-made second cooling tower packing 544 can be reduced compared with the total weight in the case where the cooling tower packing 51 is made of metal, thereby preventing the structure that supports the packing from being increased in size.

### Processing Example of Cooling Tower Control Unit

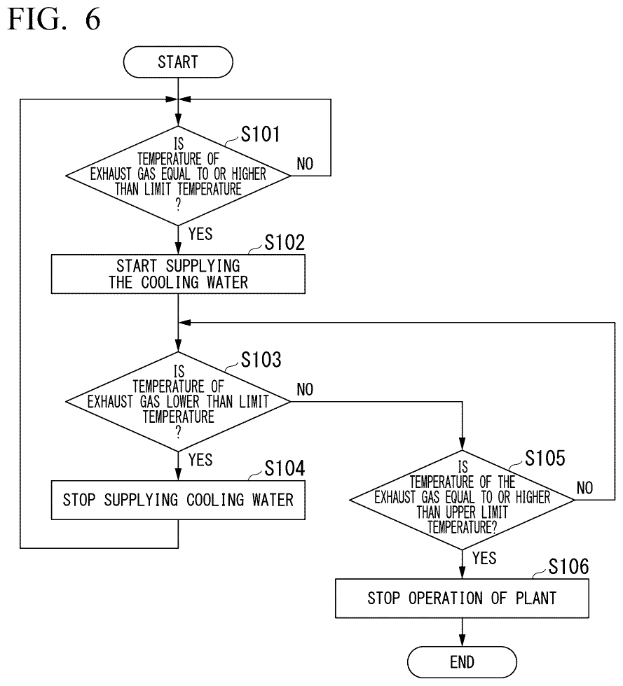

FIG. 6 is a flowchart showing an example of processing of the cooling tower control unit according to the first embodiment of the present disclosure. Here, an example will be described in which the cooling tower control unit 56 supplies the cooling water to the cooling section 54 only in the case where the temperature of the exhaust gas G1 increases.

The cooling tower control unit 56 acquires measured values of the first temperature sensor 501 and the second temperature sensors 502 and 503 for each predetermined processing cycle and monitors whether the temperature of the exhaust gas G1 is equal to or higher than the limit temperature corresponding to the heat resistance temperature of the cooling tower packing 51 (step S101). The limit temperature is set to be lower than the heat resistance temperature by, for example, a predetermined temperature. In the case where only one temperature sensor is provided (for example, in the case where only the first temperature sensor 501 is provided), the cooling tower control unit 56 monitors whether the measured value of the temperature sensor is equal to or higher than the limit temperature. In addition, in the case where a plurality of temperature sensors are provided (for example, in the case where the second temperature sensors 502 and 503 are provided, or in the case where both the first temperature sensor 501 and the second temperature sensors 502 and 503 are provided), the cooling tower control unit 56 monitors whether the measured value of any one temperature sensor is equal to or higher than the limit temperature. In the case where the second temperature sensors 502 and 503 are provided, measuring the temperature at a plurality of locations can prevent the detection of the temperature rise occurring only at a specific location from being omitted when the condensed water does not flow evenly in the cooling tower packing 51 and temperature distribution becomes uneven.

In the case where the temperature of the exhaust gas G1 is lower than the limit temperature (step S101; NO), the cooling tower control unit 56 waits until the next measured value is acquired.

On the other hand, in the case where the temperature of the exhaust gas G1 is equal to or higher than the limit temperature (step S101; YES), the cooling tower control unit 56 starts supplying the cooling water to the cooling section 54 (step S102). Specifically, the cooling tower control unit 56 opens the cooling water control valve 542 of the cooling section 54 so that some of the cooled condensed water flows from the condensed water circulation flow passage 521 to the cooling water flow passage 541. The cooling tower control unit 56 adjusts the opening degree of the cooling water control valve 542 such that, for example, the flow rate of the cooling water increases as the temperature of the exhaust gas G1 increases. Thus, the cooling water distribution section 543 supplies the cooling water to the exhaust gas introduction flow passage 50A (FIG. 2 or 5), to below the cooling tower packing 51 (FIG. 3), or to the second cooling tower packing 544 (FIG. 4) and lowers the temperature of the exhaust gas G1 before the exhaust gas G1 flows into the cooling tower packing 51.

Next, the cooling tower control unit 56 determines whether the temperature of the exhaust gas G1 is lower than the limit temperature (step S103). In the case where the temperature of the exhaust gas G1 is lower than the limit temperature (step S103; YES), the cooling tower control unit 56 closes the cooling water control valve 542 of the cooling section 54 to stop supplying the cooling water (step S104). After that, the processing in FIG. 6 is repeatedly executed for each processing cycle.

On the other hand, in the case where the temperature of the exhaust gas G1 is not lower than the limit temperature (step S103; NO), the cooling tower control unit 56 determines whether the temperature of the exhaust gas G1 has further risen to be equal to or higher than an upper limit temperature higher than the limit temperature (step S105). In the case where the temperature of the exhaust gas G1 is lower than the upper limit temperature higher than the limit temperature (step S105; NO), the cooling tower control unit 56 returns to step S103 and waits until the next measured value is acquired.

In the case where the temperature of the exhaust gas G1 has further risen to be equal to or higher than the upper limit temperature higher than the limit temperature (step S105; YES), the cooling tower control unit 56 stops the operation of the plant 1 and the supply of the exhaust gas G1 is cut off. The upper limit temperature may be set to, for example, any value between the heat resistance temperature of the cooling tower packing and the limit temperature. As a result, in the case where it is difficult to lower the temperature of the exhaust gas G1 only with the cooling water, it is possible to prevent the deformation or damage to the cooling tower packing 51 due to the high-temperature exhaust gas G1 exceeding the upper limit temperature.

Note that FIG. 6 is an example, and some of the processing may be added or changed in another embodiment. For example, the cooling tower control unit 56 executes the following processing instead of steps S105 and S106 or before steps S105 and S106. The cooling tower control unit 56 further sets a predetermined second limit temperature between the limit temperature and the upper limit temperature. In the case where the temperature of the exhaust gas G1 is not lower than the limit temperature (step S103; NO) and is equal to or higher than the second limit temperature, the flow rate of the exhaust gas G1 is reduced. Thereafter, in the case where the temperature of the exhaust gas G1 is lower than the second limit temperature, the flow rate of the exhaust gas G1 is restored, and in the case where the temperature of the exhaust gas G1 is lower than the limit temperature (step S103; YES), the supply of the cooling water is stopped (step S104). In the case where processing of reducing the flow rate of the exhaust gas G1 is added before steps S105 and S106, the operation of the plant 1 is stopped (step S106) when the temperature of the exhaust gas G1 is equal to or higher than the upper limit temperature (step S105; YES) even though the flow rate of the exhaust gas G1 is reduced. In this way, by reducing the flow rate of the exhaust gas G1 before stopping the operation of the plant 1, it is possible to prevent the deformation or damage to the cooling tower packing 51 while preventing a decrease in the operation rate of the plant 1.

In addition, in still another embodiment, in the case where the temperature of the exhaust gas G1 is equal to or higher than the limit temperature (step S101; YES), the operation of the plant 1 may be stopped. As a result, the deformation or damage to the cooling tower packing 51 can be more reliably prevented.

### Action and Effect

As described above, according to the present embodiment, the cooling tower 5 includes the resin-made cooling tower packing 51 that cools the exhaust gas G1 flowing inside the cooling tower 5 (main body section 50) from the lower part to the upper part in the vertical direction, the condensed water circulation section 52 including the condensed water circulation flow passage 521 through which the condensed water stored in the lower part of the cooling tower 5 is pumped up by a pump 522 and circulated to the upper part of the cooling tower 5, and the heat exchanger 523 that cools the condensed water flowing through the condensed water circulation flow passage 521, the condensed water distribution section 53 connected to the condensed water circulation flow passage 521 at the upper part of the cooling tower 5 and that supplies the condensed water from above the cooling tower packing 51 to the cooling tower packing 51, and the cooling section 54 including the cooling water distribution section 543 that supplies the cooling water for cooling the exhaust gas G1 to the upstream side of the cooling tower packing 51 in the flow direction of the exhaust gas G1.

The cooling tower 5 can prevent the high-temperature exhaust gas G1 exceeding the heat resistance temperature from flowing into the resin-made cooling tower packing 51. As a result, the risk of deformation or damage to the cooling tower packing 51 can be reduced, thereby extending the lifespan of the cooling tower packing 51.

The cooling water distribution section 543 of the cooling section 54 supplies the cooling water to the inside of the exhaust gas introduction flow passage 50A through which the exhaust gas G1 is introduced into the cooling tower 5.

The cooling tower 5 can lower the temperature of the exhaust gas G1 before the exhaust gas G1 flows into the cooling tower 5. Therefore, it is possible to prevent the high-temperature exhaust gas G1 exceeding the heat resistance temperature from flowing into the resin-made cooling tower packing 51.

In addition, the cooling water distribution section 543 of the cooling section 54 supplies the cooling water to the cooling tower packing 51 from below the cooling tower packing 51.

The cooling tower 5 can cool the lower side of the cooling tower packing 51 with the cooling water together with the exhaust gas G1, thereby preventing the exhaust gas G1 and the cooling tower packing 51 from being high temperature exceeding the heat resistance temperature of the cooling tower packing 51. Further, the temperature of the exhaust gas G1 is higher toward the lower part of the cooling tower packing 51 (toward the upstream side in the flow direction). Therefore, as the cooling tower 5 supplies the cooling water toward a location where the temperature of the cooling tower packing 51 is likely to rise, the temperatures of the exhaust gas G1 and the cooling tower packing 51 can be appropriately lowered.

Additionally, the cooling section 54 further includes the second cooling tower packing 544 disposed below the cooling tower packing 51 and that has a heat resistance temperature higher than that of the cooling tower packing 51.

The cooling tower 5 can lower the temperature of the exhaust gas G1 with the second cooling tower packing 544 having a higher heat resistance temperature before the exhaust gas G1 flows through the cooling tower packing 51. Therefore, it is possible to prevent the high-temperature exhaust gas G1 exceeding the heat resistance temperature from flowing into the resin-made cooling tower packing 51.

The second cooling tower packing 544 is disposed below the cooling tower packing 51 and spaced apart from the cooling tower packing 51, and the cooling water distribution section 543 is provided between the cooling tower packing 51 and the second cooling tower packing 544 and supplies the cooling water to the second cooling tower packing 544.

The cooling tower 5 can more reliably lower the temperature of the exhaust gas G1 before the exhaust gas G1 reaches the cooling tower packing 51 by using the second cooling tower packing 544 and the cooling water.

The cooling section 54 includes the cooling water flow passage 541 that branches from the condensed water circulation flow passage 521 at a downstream side of the heat exchanger 523 and through which some of the condensed water cooled by the heat exchanger 523 is introduced into the cooling water distribution section 543 as the cooling water.

By reusing the condensed water of the condensed water circulation section 52 in this way, the cooling tower 5 does not need to introduce the cooling water from outside the system, and the operating cost of the cooling tower 5 can be reduced. Additionally, since the condensed water that has been cooled by the heat exchanger 523 of the condensed water circulation section 52 is used as the cooling water, the temperature of the exhaust gas G1 can be effectively lowered.

In addition, the cooling tower 5 further includes the cooling tower control unit 56 that causes the cooling section 54 to supply the cooling water in the case where the temperature of the exhaust gas G1 is equal to or higher than the limit temperature, and causes the cooling section 54 to stop supplying the cooling water in the case where the temperature of the exhaust gas G1 is lower than the limit temperature.

The cooling tower 5 can lower the temperature of the exhaust gas G1 with the cooling water in the case where the temperature of the exhaust gas G1 is equal to or higher than the limit temperature, and can stop supplying the cooling water in the case where the temperature of the exhaust gas G1 is lower than the limit temperature, thereby reducing the pump power required for the supply.

Moreover, the cooling tower control unit 56 stops the operation of the plant 1 in the case where the temperature of the exhaust gas G1 is equal to or higher than the upper limit temperature higher than the limit temperature.

The cooling tower 5 can prevent the deformation or damage to the cooling tower packing 51 due to the high-temperature exhaust gas G1 exceeding the upper limit temperature even in the case where it is difficult to lower the temperature of the exhaust gas G1 only by using the cooling water.

### Second Embodiment

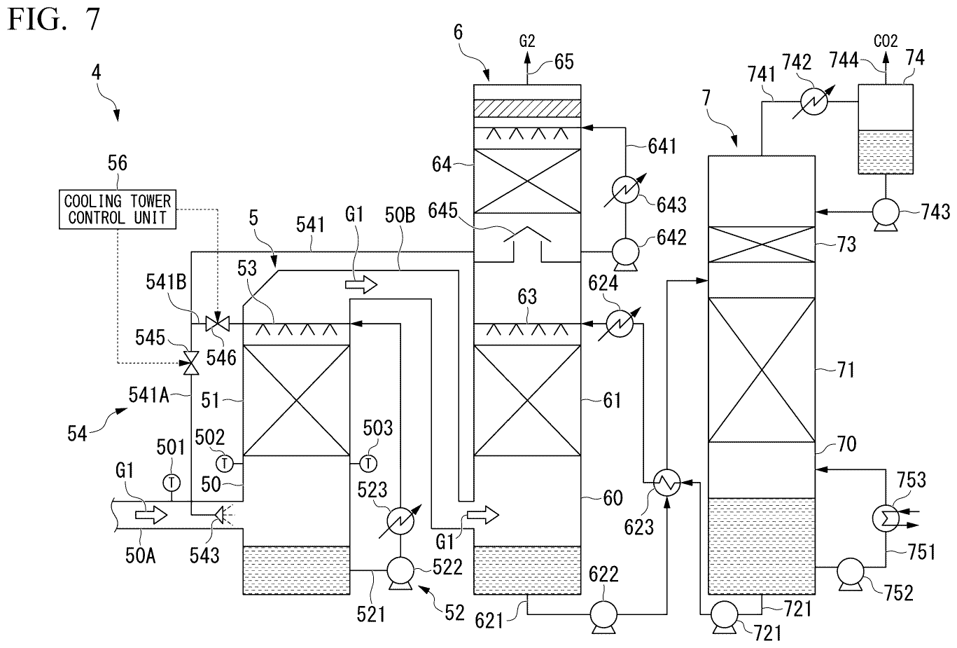

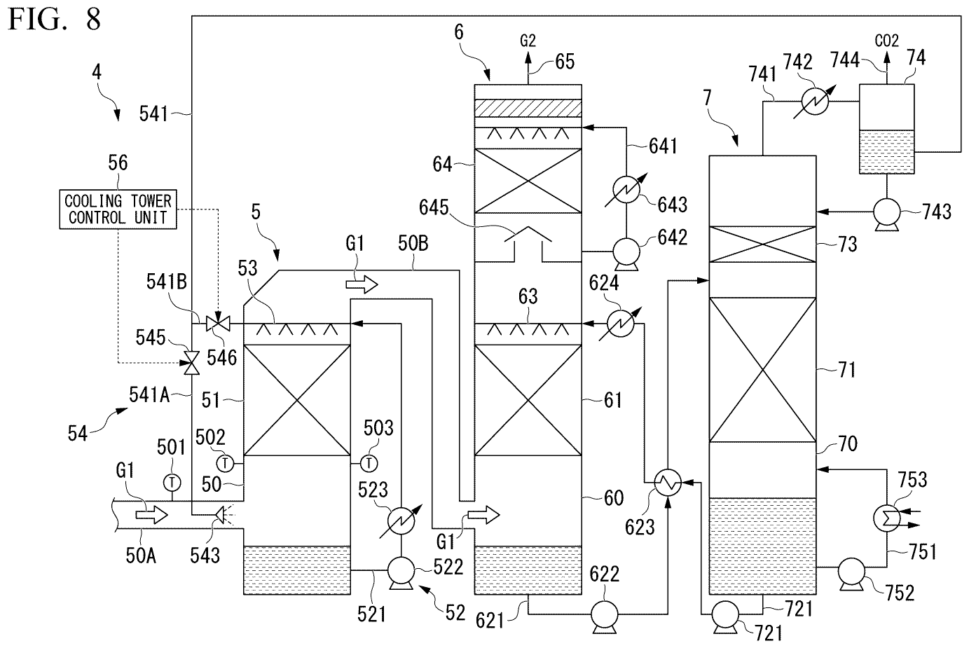

Next, a second embodiment will be described in detail with reference to FIGS. 7 and 8. The same components as those in the first embodiment are designated by the same reference numerals, and the detailed descriptions thereof will be omitted.

### Configuration Example of Absorption Tower and Regeneration Tower

FIG. 7 is a first schematic diagram showing an example of the configuration of a carbon dioxide capture device according to a second embodiment of the present disclosure. First, an example of a configuration of the absorption tower 6 will be described. As shown in FIG. 7, the absorption tower 6 includes a main body section 60, an absorption section packing 61, an absorbing liquid distribution section 63, an absorption tower washing section 64, and a purified gas discharge flow passage 65.

The main body section 60 is a hollow container that extends in the vertical direction, and the exhaust gas G1 cooled by the cooling tower 5 flows in the vertical direction inside the main body section 60. The absorption section packing 61 is a packing provided inside the main body section 60. The absorbing liquid distribution section 63 supplies the absorbing liquid (lean absorbing liquid) regenerated by the regeneration tower 7 to the absorption section packing 61. In the absorption section packing 61, the exhaust gas G1 and the absorbing liquid come into gas-liquid contact with each other, and carbon dioxide contained in the exhaust gas G1 is absorbed by the absorbing liquid and removed. The absorption tower washing section 64 washes the exhaust gas from which the carbon dioxide has been removed with washing water and discharges the washed exhaust gas as the purified gas G2 from the purified gas discharge flow passage 65 at the top of the absorption tower 6.

The washing water used in the absorption tower washing section 64 is stored in a chimney tray 645 provided between the absorption section packing 61 and the absorption tower washing section 64. The washing water stored in the chimney tray 645 is pumped up by a pump 642 and is supplied from above the absorption tower washing section 64 through a washing water circulation flow passage 641. In addition, a heat exchanger 643 is provided in the washing water circulation flow passage 641 and cools the washing water to be supplied to the absorption tower washing section 64.

The absorbing liquid (rich absorbing liquid) that has absorbed the carbon dioxide in the absorption section packing 61 is stored in a lower part of the main body section 60 of the absorption tower 6. The rich absorbing liquid is sent to the regeneration tower 7 through a rich absorbing liquid line 621 by a pump 622. The rich absorbing liquid is regenerated by the regeneration tower 7 to become the lean absorbing liquid and is sent to the regeneration tower 7 through a lean absorbing liquid line 721 by a pump 722. The rich absorbing liquid and the lean absorbing liquid are heat-exchanged by a heat exchanger 623. Additionally, a heat exchanger 624 that cools the lean absorbing liquid to a predetermined temperature is provided on a downstream side of the heat exchanger 623 (absorption tower 6 side) in a lean liquid flow direction of the lean absorbing liquid line 721.

Next, an example of a configuration of the regeneration tower 7 will be described. As shown in FIG. 7, the regeneration tower 7 includes a main body section 70, a regeneration section packing 71, a regeneration tower washing section 73, and a reflux drum 74.

The main body section 70 is a tubular container that extends in the vertical direction. The regeneration section packing 71 is provided inside the main body section 70. The absorbing liquid (rich absorbing liquid) that has absorbed the carbon dioxide in the absorption tower 6 is introduced above the regeneration section packing 71 through the rich absorbing liquid line 621. While the absorbing liquid flows downward through the regeneration section packing 71, the carbon dioxide is released from the rich absorbing liquid by steam. The carbon dioxide gas separated from the rich absorbing liquid flows upward in the main body section 70. The absorbing liquid (lean absorbing liquid) from which the carbon dioxide has been removed is stored in a lower portion of the main body section 70. The lean absorbing liquid is pumped up by a pump 752, flows through a lean absorbing liquid circulation flow passage 751, is heated by a reboiler 753 provided in the lean absorbing liquid circulation flow passage 751, and is returned to the main body section 70.

The regeneration tower washing section 73 supplies washing water to remove the absorbing liquid contained in the carbon dioxide gas. The carbon dioxide gas from which the absorbing liquid has been removed flows through a first discharge flow passage 741 from the top of the regeneration tower 7, and moisture contained in the carbon dioxide gas is condensed by a condenser 742 and introduced into the reflux drum 74. The reflux drum 74 separates the condensed water generated from the carbon dioxide gas and the carbon dioxide gas. The condensed water is stored in a lower part of the reflux drum 74 and is sent to the regeneration tower washing section 73 as the washing water by a pump 743. The carbon dioxide gas separated by the reflux drum 74 is discharged from the top of the reflux drum 74 to a capture tank or the like outside the system through a second discharge flow passage 744.

### Configuration Example 1 of Cooling Tower

In addition, the cooling tower 5 of the present embodiment differs from that of the first embodiment in the configuration of the cooling section 54. In Configuration Example 1 of the present embodiment, the cooling section 54 introduces the cooling water into the cooling water distribution section 543 from the cooling water supply source located at a position higher than that of the cooling water distribution section 543. The cooling water supply source is, for example, the chimney tray 645 of the absorption tower 6. One end of the cooling water flow passage 541 of the cooling section 54 is connected to the chimney tray 645 of the absorption tower 6. The other end of the cooling water flow passage 541 is connected to the cooling water distribution section 543 through the on-off valve 545. The cooling water supply source is not limited to being located inside the carbon dioxide capture system 100 and may be located outside.

Additionally, as in the example of FIG. 7, the cooling water flow passage 541 may branch into a first cooling water flow passage 541A connected to the cooling water distribution section 543 and a second cooling water flow passage 541B connected to the condensed water distribution section 53. The first cooling water flow passage 541A and the second cooling water flow passage 541B are provided with on-off valves 545 and 546. The on-off valves 545 and 546 open and close under the control of the cooling tower control unit 56. The cooling tower control unit 56 opens the on-off valves 545 and 546 to supply the cooling water to the cooling section 54 in the case where the temperature of the exhaust gas G1 exceeds the limit temperature, in the same manner as in the first embodiment. The on-off valves 545 and 546 may be manually opened and closed from outside the cooling tower 5.

### Action and Effect of Configuration Example 1

Since the washing water of the absorption tower 6 can be reused, the cooling tower 5 does not need to introduce the cooling water from outside the system, and the operating cost of the cooling tower 5 can be reduced. In addition, the chimney tray 645 of the absorption tower 6 is provided at a position higher than that of the cooling water distribution section 543 of the cooling section 54 and the condensed water distribution section 53. Therefore, simply by opening the on-off valves 545 and 546 provided in the cooling water flow passage 541, the washing water stored in the chimney tray 645 drops and is supplied as the cooling water to the cooling water distribution section 543 and the condensed water distribution section 53. Consequently, since a pump for sending the cooling water is not required, for example, even in the event of a power loss such as a power outage, the temperature of the exhaust gas G1 can be lowered by supplying the cooling water to the cooling water distribution section 543 in the case where the on-off valves 545 and 546 are open. In the case where a power loss occurs in a state in which the on-off valves 545 and 546 are closed, the worker may manually open the on-off valves 545 and 546. As a result, the deformation or damage to the cooling tower packing 51 can be prevented even in the event of a power loss.

Other configurations of the cooling section 54 are the same as those in the first embodiment. The configurations of the cooling water distribution section 543 and the second cooling tower packing 544 of the cooling section 54 may be any of the configurations shown in FIGS. 2 to 5.

### Configuration Example 2 of Cooling Tower

FIG. 8 is a second schematic diagram showing an example of a configuration of the carbon dioxide capture device according to the second embodiment of the present disclosure. In Configuration Example 2 of the present embodiment, the cooling section 54 introduces the cooling water into the cooling water distribution section 543 from a cooling water supply source having an internal pressure higher than that of the cooling tower 5. The cooling water supply source is, for example, the reflux drum 74 of the regeneration tower 7. As in the example of FIG. 8, one end of the cooling water flow passage 541 of the cooling section 54 is connected to the reflux drum 74 of the regeneration tower 7. The other end of the cooling water flow passage 541 is connected to the cooling water distribution section 543 through the on-off valve 545. The cooling water supply source is not limited to being located inside the carbon dioxide capture system 100 and may be located outside.

In addition, in the same manner as in Configuration Example 1, the cooling water flow passage 541 may branch into the first cooling water flow passage 541A connected to the cooling water distribution section 543 and the second cooling water flow passage 541B connected to the condensed water distribution section 53. The cooling tower control unit 56 opens the on-off valve 545 to supply the cooling water to the cooling section 54 in the case where the temperature of the exhaust gas G1 exceeds the limit temperature, in the same manner as in the first embodiment. The on-off valves 545 and 546 may be manually opened and closed from outside the cooling tower 5.

### Action and Effect of Configuration Example 2

Since the reflux water of the reflux drum 74 of the regeneration tower 7 can be reused, the cooling tower 5 does not need to introduce the cooling water from outside the system, and the operating cost of the cooling tower 5 can be reduced. Additionally, during the operation of the carbon dioxide capture device 4, the reflux drum 74 of the regeneration tower 7 is in a state in which the internal pressure is higher than that of the cooling tower 5. Therefore, simply by opening the on-off valves 545 and 546 provided in the cooling water flow passage 541, the condensed water stored in the reflux drum 74 is sent and supplied as the cooling water to the cooling water distribution section 543 and the condensed water distribution section 53. Consequently, since a pump for sending the cooling water is not required, for example, even in the event of a power loss such as a power outage, the temperature of the exhaust gas G1 can be lowered by supplying the cooling water to the cooling water distribution section 543 in the case where the on-off valves 545 and 546 are open. In the case where a power loss occurs in a state in which the on-off valves 545 and 546 are closed, the worker may manually open the on-off valves 545 and 546. As a result, the deformation or damage to the cooling tower packing 51 can be prevented even in the event of a power loss.

Other configurations of the cooling section 54 are the same as those in the first embodiment. The configurations of the cooling water distribution section 543 and the second cooling tower packing 544 of the cooling section 54 may be any of the configurations shown in FIGS. 2 to 5.

### Third Embodiment

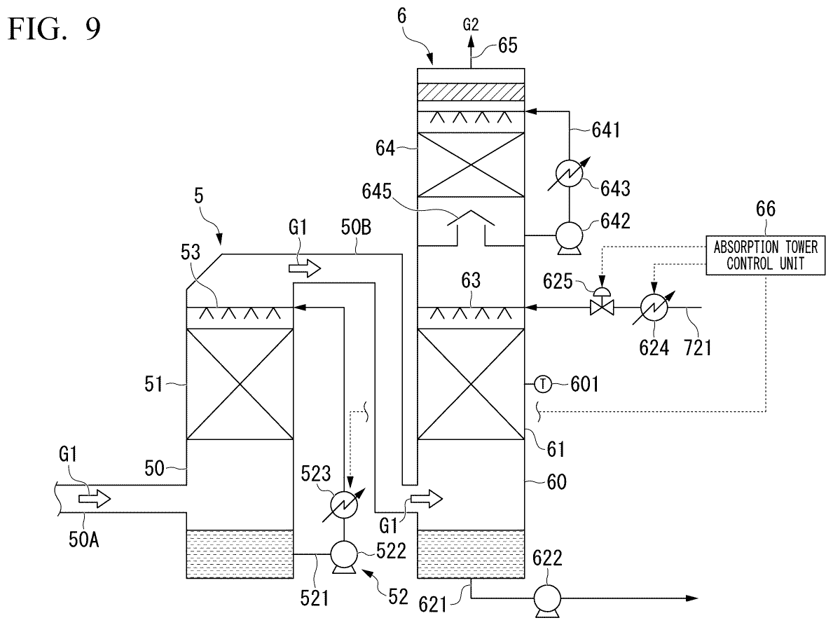

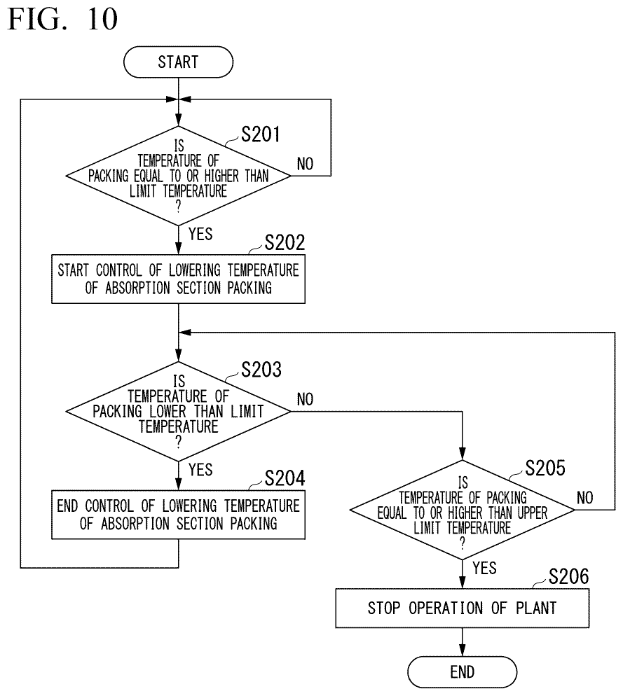

Next, a third embodiment will be described in detail with reference to FIGS. 9 and 10. The same components as those in the first embodiment are designated by the same reference numerals, and detailed descriptions thereof will be omitted.

### Configuration Example of Absorption Tower

FIG. 9 is a schematic diagram showing an example of a configuration of the absorption tower according to the third embodiment of the present disclosure. As shown in FIG. 9, the absorption tower 6 further comprises an absorption tower control unit 66 in addition to the same configuration as in the second embodiment. The absorption section packing 61 of the present disclosure is formed of a resin material. The absorption section packing 61 absorbs carbon dioxide with the absorbing liquid and generates heat. Therefore, in a case where the temperature of the absorption section packing 61 is equal to or higher than the limit temperature according to the heat resistance temperature of the absorption section packing 61, the absorption tower control unit 66 performs the process of lowering the temperature of the absorption section packing 61. Specific contents of processing will be described later.

At least one temperature sensor 601 is provided at a location where a temperature peak appears (the most carbon dioxide absorption reaction proceeds) in the absorption section packing 61. The location where the temperature peak appears is predicted in advance by calculation based on the characteristics of the absorbing liquid or the absorption section packing 61. In a case where there are a plurality of locations where the temperature peak is predicted to appear, a plurality of temperature sensors 601 may be provided.

In addition, the lean absorbing liquid line 721 may be provided with an absorbing liquid control valve 625 capable of adjusting the flow rate of the lean absorbing liquid. The absorbing liquid control valve 625 is provided on the downstream side (the absorption tower 6 side) of the heat exchanger 624 in the lean solution flow direction.

As the cooling tower 5 of the present embodiment, the same cooling tower as that of the first embodiment may be used, or a cooling tower of the related art may be used.

### Processing Example of Absorption Tower Control Unit

FIG. 10 is a flowchart showing an example of processing of an absorption tower control unit according to the third embodiment of the present disclosure. Here, an example of processing of monitoring the temperature of the absorption section packing 61 by the absorption tower control unit 66 and lowering the temperature of the absorption section packing 61 will be described.

The absorption tower control unit 66 acquires measured values of the temperature sensor 601 for each predetermined processing cycle and monitors whether the temperature of the absorption section packing 61 is equal to or higher than the limit temperature corresponding to the heat resistance temperature of the absorption section packing 61 (step S201). The limit temperature is set to be lower than the heat resistance temperature by, for example, a predetermined temperature.

In the case where the temperature of the absorption section packing 61 is lower than the limit temperature (step S201; NO), the absorption tower control unit 66 waits until the next measured value is acquired.

On the other hand, in a case where the temperature of the absorption section packing 61 is equal to or higher than the limit temperature (Step S201; YES), the absorption tower control unit 66 starts the control of lowering the temperature of the absorption section packing 61 (Step S202). Specifically, the absorption tower control unit 66 performs at least any one of the following controls (1) to (3).
(1) The absorption tower control unit 66 lowers the set temperature of the heat exchanger 624 of the lean absorbing liquid line 721 to lower the temperature of the lean absorbing liquid. The absorption tower control unit 66 further decreases the set temperature of the heat exchanger 624 within the range of the required performance of the plant 1. The temperature of the absorption section packing 61 is lowered by supplying the lean absorbing liquid at a low temperature.
(2) The absorption tower control unit 66 increases the opening degree of the absorbing liquid control valve 625 of the lean absorbing liquid line 721 to increase the flow rate of the lean absorbing liquid. The temperature of the absorption section packing 61 decreases as the supply amount of the lean absorbing liquid increases.
(3) The absorption tower control unit 66 lowers the set temperature of the heat exchanger 523 of the condensed water circulation flow passage 521 of the cooling tower 5 to further lower the temperature of the exhaust gas G1 discharged from the cooling tower 5 (flowing into the absorption tower 6). The absorption tower control unit 66 decreases the set temperature of the heat exchanger 523 within the range of the required performance of the plant 1. By lowering the temperature of the exhaust gas G1, the temperature of the absorption section packing 61 is also lowered.

The absorption tower control unit 66 may execute only one of (1) to (3), or may execute two or more of (1) to (3) in combination (simultaneously or in order). In a case where (2) is not executed, the absorbing liquid control valve 625 may be omitted.

Next, the absorption tower control unit 66 determines whether the temperature of the absorption section packing 61 is lower than the limit temperature (step S203). In a case where the temperature of the absorption section packing 61 is lower than the limit temperature (step S203; YES), the absorption tower control unit 66 ends the executed controls (1) to (3) (step S204). That is, in a case where the control (1) is executed, the set temperature of the heat exchanger 624 of the lean absorbing liquid line 721 is returned to the set temperature before the change. In a case where the control of (2) is executed, the opening degree of the absorbing liquid control valve 625 of the lean absorbing liquid line 721 is returned to the opening degree before the change. In a case where the control of (3) is executed, the set temperature of the heat exchanger 523 of the cooling tower 5 is returned to the set temperature before the change.

On the other hand, in the case where the temperature of the absorption section packing 61 is not lower than the limit temperature (step S203; NO), the absorption tower control unit 66 determines whether the temperature of the absorption section packing 61 has further risen to be equal to or higher than an upper limit temperature higher than the limit temperature (step S205). In the case where the temperature of the absorption section packing 61 is lower than the upper limit temperature (step S205; NO), the absorption tower control unit 66 returns to step S203 and waits until the next measured value is acquired.

In addition, in a case where the temperature of the absorption section packing 61 is equal to or higher than the upper limit temperature (Step S205; YES), the absorption tower control unit 66 stops the operation of the plant 1 (Step S206) and stops the supply of the exhaust gas G1. Accordingly, in a case where it is difficult to decrease the temperature of the absorption section packing 61 in the controls (1) to (3), the supply of the exhaust gas G1 is stopped to reduce the reaction of carbon dioxide absorption, so that the temperature of the absorption section packing 61 can be decreased and the deformation or damage can be prevented.

### Action and Effect

As described above, in the absorption tower 6 according to the present embodiment, in a case where the temperature of the absorption section packing 61 is equal to or higher than the limit temperature corresponding to the heat resistance temperature of the absorption section packing 61, the absorption tower control unit 66 decreases the set temperature of the heat exchanger 624 of the lean absorbing liquid line 721.

In this way, the absorption tower 6 can further lower the temperature of the lean absorbing liquid to lower the temperature of the absorption section packing 61. As a result, the deformation or damage to the absorption section packing 61 due to high temperatures can be prevented.

In addition, in a case where the temperature of the absorption section packing 61 is equal to or higher than the limit temperature, the absorption tower control unit 66 increases the opening degree of the absorbing liquid control valve 625 of the lean absorbing liquid line 721.

In this manner, the absorption tower 6 can decrease the temperature of the absorption section packing 61 by the amount of increase in the flow rate of the lean absorbing liquid to the absorption section packing 61.

In addition, in a case where the temperature of the absorption section packing 61 is equal to or higher than the limit temperature, the absorption tower control unit 66 decreases the set temperature of the heat exchanger 523 of the condensed water circulation flow passage 521 of the cooling tower 5.

In this manner, the absorption tower 6 can lower the temperature of the absorption section packing 61 by the temperature of the exhaust gas G1 introduced into the absorption tower 6 being lowered.

### Modification Example 1 of Third Embodiment

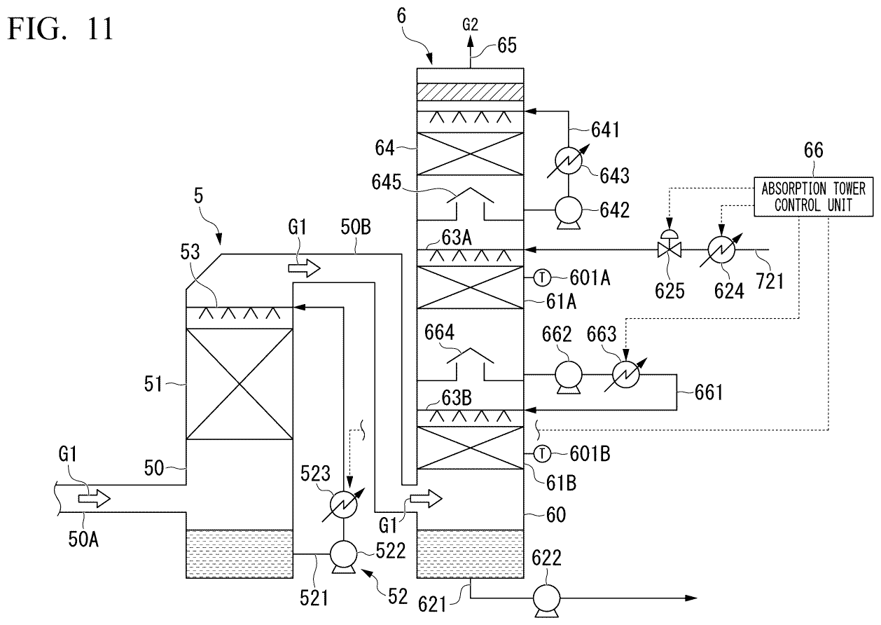

FIG. 11 is a schematic diagram showing an example of the configuration of an absorption tower according to a modification example 1 of the third embodiment of the present disclosure. As shown in FIG. 11, the absorption tower 6 may have two sets of the absorption section packing 61 and the absorbing liquid distribution section 63.

Specifically, the absorption tower 6 comprises a first absorption section packing 61A and a second absorption section packing 61B. The second absorption section packing 61B is provided below the first absorption section packing 61A. Both the first absorption section packing 61A and the second absorption section packing 61B are formed of a resin material. In addition, a first absorbing liquid distribution section 63A is provided above the first absorption section packing 61A, and the lean absorbing liquid introduced from the regeneration tower 7 through the lean absorbing liquid line 721 is supplied to the first absorption section packing 61A. The absorbing liquid (semi-rich absorbing liquid) in which carbon dioxide is absorbed in the first absorption section packing 61A is stored in the second chimney tray 664 provided between the first absorption section packing 61A and the second absorption section packing 61B. A second absorbing liquid distribution section 63B is provided above the second absorption section packing 61B. The semi-rich absorbing liquid stored in the second chimney tray 664 flows to the second absorbing liquid distribution section 63B by the pump 662 through the semi-rich absorbing liquid line 661. A heat exchanger 663 that cools the semi-rich absorbing liquid is provided in the semi-rich absorbing liquid line 661. The second absorbing liquid distribution section 63B supplies the semi-rich absorbing liquid cooled by the heat exchanger 663 to the second absorption section packing 61B.

In the present modification example, the absorption tower control unit 66 monitors the temperature of the first absorption section packing 61A by the temperature sensor 601A, and monitors the temperature of the second absorption section packing 61B by the temperature sensor 601B. For example, in a case where the temperature of the first absorption section packing 61A is equal to or higher than the limit temperature, the absorption tower control unit 66 performs at least one control of (1) to (3) of the third embodiment to lower the temperature of the first absorption section packing 61A. In addition, in a case where the temperature of the second absorption section packing 61B is equal to or higher than the limit temperature, the absorption tower control unit 66 performs the following control (4).
(4) The absorption tower control unit 66 lowers the set temperature of the heat exchanger 663 of the semi-rich absorbing liquid line 661 to further lower the temperature of the semi-rich absorbing liquid. The absorption tower control unit 66 further decreases the set temperature of the heat exchanger 624 within the range of the required performance of the plant 1. The temperature of the second absorption section packing 61B is lowered by supplying the semi-rich absorbing liquid at a low temperature.

In addition, the absorption tower control unit 66 may perform the control of (3) described above instead of the control of (4) or in addition to the control of (4).

In this manner, as in the example of FIG. 10, even in an absorption tower including two absorption section packings 61A and 61B, the temperature of each of the absorption section packings 61A and 61B can be lowered to prevent deformation or damage.

### Modification Example 2 of Third Embodiment

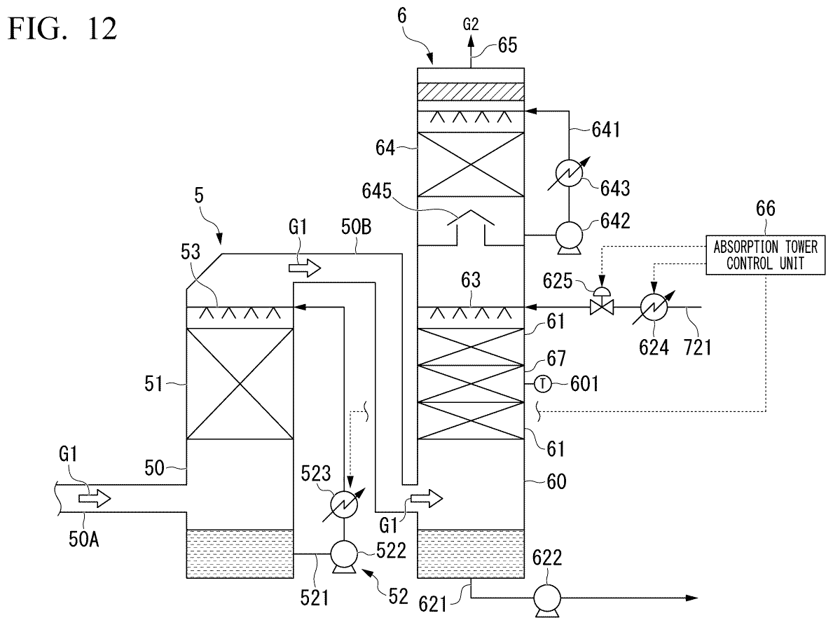

FIG. 12 is a schematic diagram showing an example of the configuration of an absorption tower according to a modification example 2 of the third embodiment of the present disclosure. As shown in FIG. 12, the absorption tower 6 may further have a third absorption section packing 67 in addition to the configuration of the third embodiment described above. The third absorption section packing 67 is a packing made of a metal having a higher heat resistance temperature than the resin-made absorption section packing 61.

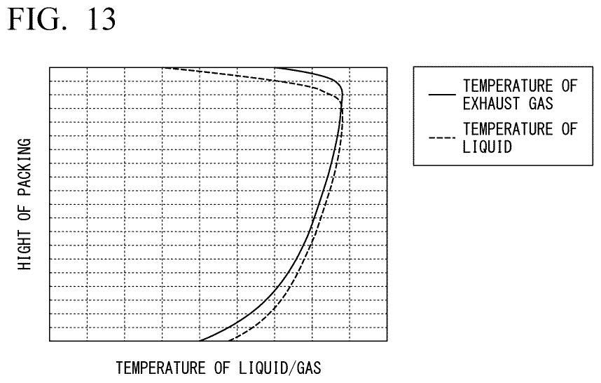

FIG. 13 is a diagram showing an example of a temperature profile of an absorption tower packing. FIG. 13 shows an example of a change in temperature of the exhaust gas G1 and the absorbing liquid at the position of the absorption tower packing 61 in the up-down direction. The lower end and the upper end of the vertical axis of FIG. 13 correspond to the positions of the lower end and the upper end of the absorption section packing 61, respectively. The horizontal axis of FIG. 13 indicates that the temperature is higher toward the right side. Since the absorption tower 6 is an exothermic reaction, the temperature of the exhaust gas G1 introduced into the absorption tower 6 after being cooled by the cooling tower 5 rises while coming into contact with the absorbing liquid in a case where the exhaust gas G1 flows above the absorption tower 6. The temperature of the exhaust gas G1 is lowered by the supplied absorbing liquid at the upper end of the absorption section packing 61. Therefore, as in the example of FIG. 13, a temperature peak appears on the upper side (a position slightly lower than the upper end) of the interlayer of the absorption section packing 61. In the vicinity of this temperature peak, there is a possibility that the heat resistance temperature of the resin-made absorption section packing 61 may be exceeded.

In view of this, in the present embodiment, the third absorption section packing 67 is provided to be interposed in the absorption section packing 61. More specifically, the third absorption section packing 67 is provided at a position where the temperature peak shown in FIG. 13 appears.

In the absorption tower 6 according to Modification Example 2, as described above, the third absorption section packing 67 having a higher heat resistance temperature than the absorption section packing 61 is provided in the absorption section packing 61, so that the resin-made absorption section packing 61 can be disposed to avoid the vicinity of the temperature peak of the exhaust gas G1 (at a position where the heat resistance temperature of the absorption section packing 61 may be exceeded). As a result, the deformation or damage to the absorption section packing 61 can be more reliably prevented.

### Modification Example 3 of Third Embodiment

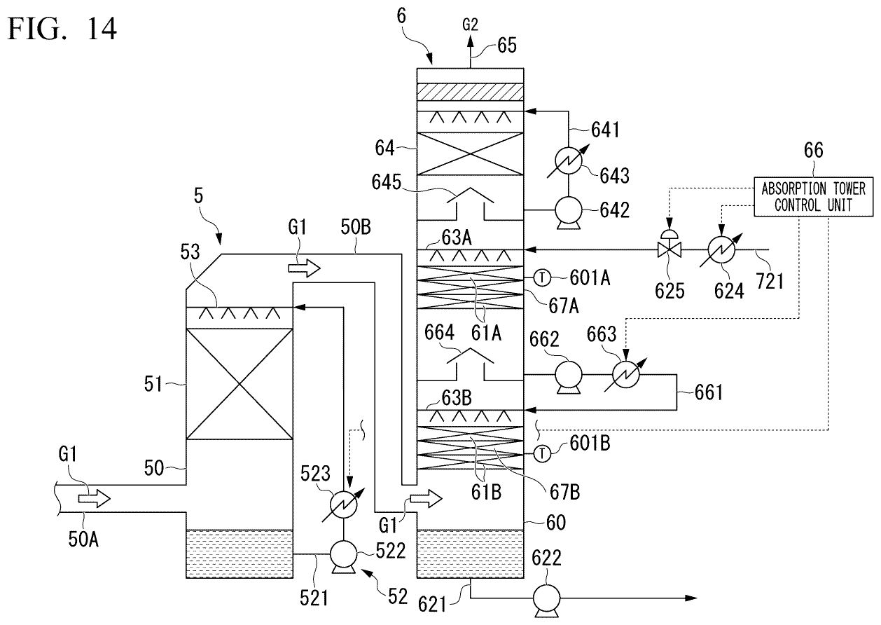

FIG. 14 is a schematic diagram showing an example of the configuration of an absorption tower according to a modification example 3 of the third embodiment of the present disclosure. The absorption tower 6 may have a configuration in which modification example 1 and Modification Example 2 are combined. That is, in modification example 3, as shown in FIG. 14, the third absorption section packings 67A and 67B may be provided to be interposed in the first absorption section packing 61A and the second absorption tower packing 61B, respectively.

In addition, in still another modification example, the third absorption section packing 67 may be provided only in one of the first absorption section packing 61A and the second absorption tower packing 61B.

As described in Modification Example 2 (FIG. 13), the upper side of the interlayer of the absorption tower 6 tends to be at a high temperature. However, since the temperature distribution in the absorption tower 6 differs depending on the flow rate of the exhaust gas G1, the liquid amount of the absorbing liquid, and the like, which portion has the highest temperature and exceeds the heat resistance temperature of the resin absorption section packings 61A and 61B depends on the operating conditions of the carbon dioxide capture device 4. Therefore, whether the third absorption section packing 67A is provided only in the first absorption section packing 61A, the third absorption section packing 67B is provided only in the second absorption packing 61B, or the third absorption section packings 67A and 67B are provided in both the first absorption section packing 61A and the second absorption section packing 61B may be optionally determined according to the operating conditions of the carbon dioxide capture device 4 and the like.

In the absorption tower 6 according to Modification Example 3, similarly to Modification Example 2, the third absorption section packings 67A and 67B having a higher heat resistance temperature than the absorption section packings 61A and 61B are provided between the absorption section packings 61A and 61B, so that the resin absorption section packings 61A and 61B can be disposed to avoid the temperature peak of the exhaust gas G1 (a position where the heat resistance temperature of the absorption section packings 61A and 61B may be exceeded). As a result, the deformation or damage of the absorption section packings 61A and 61B can be more effectively prevented.

### Computer Configuration

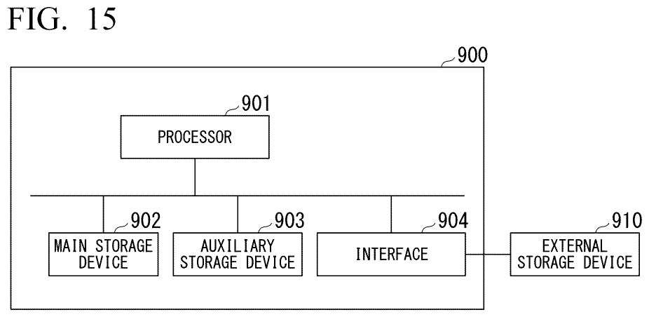

FIG. 15 is a schematic block diagram showing the configuration of a computer of the control unit according to at least one embodiment. A computer 900 includes a processor 901, a main storage device 902, an auxiliary storage device 903, and an interface 904.

The cooling tower control unit 56 of the cooling tower 5 and the absorption tower control unit 66 of the absorption tower 6 are mounted on the computer 900, respectively. The operation of the cooling tower control unit 56 mentioned above is stored in the auxiliary storage device 903 in a form of a program. The processor 901 reads the program from the auxiliary storage device 903, expands the program into the main storage device 902, and executes the above-described processing in accordance with the program. In addition, the processor 901 secures a storage area corresponding to each storage unit mentioned above in the main storage device 902 in accordance with the program.

The program may be used to implement some of the functions of the computer 900. For example, the program may exhibit the functions through a combination with other programs already stored in the auxiliary storage device 903 or a combination with other programs implemented in other devices. In another embodiment, the computer 900 may include a custom large-scale integrated circuit (LSI) such as a programmable logic device (PLD), in addition to the above-described configuration or instead of the above-described configuration. A programmable array logic (PAL), a generic array logic (GAL), a complex programmable logic device (CPLD), a field programmable gate array (FPGA), and the like are exemplary examples of the PLD. In such a case, some or all of the functions implemented by the processor 901 may be implemented by the integrated circuit.

A hard disk drive (HDD), a solid-state drive (SSD), a magnetic disk, a magneto-optical disk, a compact disc read-only memory (CD-ROM), a digital versatile disc read-only memory (DVD-ROM), a semiconductor memory, and the like are exemplary examples of the auxiliary storage device 903. The auxiliary storage device 903 may be an internal medium connected directly to a bus of the computer 900 or an external storage device 910 connected to the computer 900 via the interface 904 or a communication line. Additionally, in the case where this program is distributed to the computer 900 via the communication line, the computer 900 that has received the distribution may expand the program into the main storage device 902 and execute the above-described processing. In at least one embodiment, the auxiliary storage device 903 is a non-transitory tangible storage medium.

As described above, several embodiments related to the present disclosure have been described above; however, all of these embodiments are presented as examples and are not intended to limit the scope of the invention. These embodiments can be implemented in various other forms, and various omissions, replacements, and changes can be made within the scope that does not depart from the gist of the invention. These embodiments and modifications thereof are included within the scope of the invention described in the claims and the equivalent scope thereof, as well as within the scope and the gist of the invention.

### Appendix

The carbon dioxide capture device, and the method for protecting an absorption section packing described in the above-mentioned embodiments are understood to be, for example, as follows.
(1) According to the first aspect, a carbon dioxide capture device 4 includes: a cooling tower 5 that is configured to cool exhaust gas G1; an absorption tower 6 that is configured to absorb carbon dioxide contained in the exhaust gas G1 cooled in the cooling tower 5 into an absorbing liquid to remove the carbon dioxide; and a regeneration tower 7 that is configured to separate the carbon dioxide from the absorbing liquid discharged from the absorption tower 6 to regenerate the absorbing liquid, in which the absorption tower 6 includes: an absorption section packing 61 made of a resin, which is configured to bring the absorbing liquid and the exhaust gas G1 into gas-liquid contact, and an absorption tower control unit 66 that is configured to perform control to lower a temperature of the absorption section packing 61 in a case where the temperature of the absorption section packing 61 is equal to or higher than a limit temperature corresponding to the heat resistance temperature of the absorption section packing 61.

In this way, the absorption tower 6 can lower the temperature of the absorption section packing 61. As a result, the deformation or damage to the absorption section packing 61 due to high temperatures can be prevented.
(2) According to the second aspect, in the carbon dioxide capture device 4 according to the first aspect, the absorption tower 6 further includes: a lean absorbing liquid line 721 that supplies the absorbing liquid regenerated in the regeneration tower 7 to the absorption tower 6, and a heat exchanger 624 that is provided in the lean absorbing liquid line 721 and configured to cool the absorbing liquid, and the absorption tower control unit 66 is configured to lower the set temperature of the heat exchanger 624 in the lean absorbing liquid line 721 in a case where the temperature of the absorption section packing 61 is equal to or higher than the limit temperature corresponding to the heat resistance temperature of the absorption section packing 61.

In this way, the absorption tower 6 can further lower the temperature of the lean absorbing liquid to lower the temperature of the absorption section packing 61.
(3) According to the third aspect, in the carbon dioxide capture device 4 according to the first or second aspect, the absorption tower 6 further includes: a lean absorbing liquid line 721 that supplies the absorbing liquid regenerated in the regeneration tower 7 to the absorption tower 6, and an absorbing liquid control valve 625 that is provided in the lean absorbing liquid line 721 and adjusts the flow rate of the absorbing liquid, and the absorption tower control unit 66 is configured to increase an opening degree of the absorbing liquid control valve 625 in a case where the temperature of the absorption section packing 61 is equal to or higher than the limit temperature corresponding to the heat resistance temperature of the absorption section packing 61.

In this manner, the absorption tower 6 can decrease the temperature of the absorption section packing 61 by the amount of increase in the flow rate of the lean absorbing liquid to the absorption section packing 61.
(4) According to the fourth aspect, in the carbon dioxide capture device 4 according to any one of the first to third aspects, the cooling tower 5 comprises a condensed water circulation section 52 having a condensed water circulation flow passage 521 that circulates the condensed water stored in a lower portion of the cooling tower 5 to an upper part of the cooling tower 5 by pumping up the condensed water by the pump 522, and a heat exchanger 523 that cools the condensed water flowing through the condensed water circulation flow passage 521, and the absorption tower control unit 66 reduces the set temperature of the heat exchanger 523 of the condensed water circulation flow passage 521 of the cooling tower 5 in a case where the temperature of the absorption section packing 61 is equal to or higher than a limit temperature corresponding to the heat resistance temperature of the absorption section packing 61.

In this manner, the absorption tower 6 can lower the temperature of the absorption section packing 61 by the temperature of the exhaust gas G1 introduced into the absorption tower 6 being lowered.
(5) According to the fifth aspect, in the carbon dioxide capture device 4 according to any one of the first to fourth aspects, the absorption tower control unit 66 is configured to end the control of lowering the temperature of the absorption section packing 61 in a case where the temperature of the absorption section packing 61 is lower than the limit temperature.

In this way, in a case where the temperature of the absorption section packing 61 is sufficiently lowered, the carbon dioxide capture device 4 can be returned to the operating state according to the request.
(6) According to the sixth aspect, in the carbon dioxide capture device 4 according to any one of the first to fifth aspects, the carbon dioxide capture device 4 is provided in a plant 1 configured to discharge the exhaust gas G1, and the absorption tower control unit 66 is configured to stop an operation of the plant 1 in the case where the temperature of the absorption section packing 61 is equal to or higher than an upper limit temperature higher than the limit temperature.

In this manner, in a case where it is difficult to lower the temperature of the absorption section packing 61, the absorption tower 6 can stop the operation of the plant 1 to prevent the deformation or damage of the absorption section packing 61 due to the high temperature.
(7) According to the seventh aspect, in the carbon dioxide capture device 4 according to any one of the first to sixth aspects, the absorption tower 6 further includes: a first absorption section packing 61A which is the absorption section packing 61, a second absorption section packing 61B made of a resin, which is provided below the first absorption section packing 61A and is configured to bring the absorbing liquid and the exhaust gas G1 into gas-liquid contact with each other, a second chimney tray 664 which is provided between the first absorption section packing 61A and the second absorption section packing 61B and stores the absorbing liquid in which carbon dioxide is absorbed in the first absorption section packing 61A, a semi-rich absorbing liquid line 661 which supplies the absorbing liquid stored in the second chimney tray 664 to the second absorption section packing 61B, and a heat exchanger 663 which is provided in the semi-rich absorbing liquid line 661 and cools the absorbing liquid, and the absorption tower control unit 66 is configured to lower a set temperature of the heat exchanger 663 in the semi-rich absorbing liquid line 661 in a case where a temperature of the second absorption section packing 61B is equal to or higher than a limit temperature corresponding to the heat resistance temperature of the second absorption section packing 61B.

In this manner, even in an absorption tower including the two absorption section packings 61A and 61B, the temperature of each of the absorption section packings 61A and 61B can be lowered to prevent deformation or damage.
(8) According to the eighth aspect, in the carbon dioxide capture device 4 according to any one of the first to sixth aspects, the absorption tower 6 further includes a third absorption section packing 67 made of a metal, which is provided to be interposed in the absorption section packing 61.

In this way, by providing the third absorption section packing 67 having a higher heat resistance temperature than the absorption section packing 61 in the middle of the absorption section packing 61, the resin-made absorption section packing 61 can be disposed to avoid the vicinity of the temperature peak of the exhaust gas G1 (a position where the temperature may exceed the heat resistance temperature of the absorption section packing 61). As a result, the deformation or damage to the absorption section packing 61 can be more reliably prevented.
(9) According to the ninth aspect, in the carbon dioxide capture device 4 according to the seventh aspect, the absorption tower 6 further includes a metal third absorption section packing 67 that is provided to be interposed in at least one of the first absorption section packing 61A or the second absorption section packing 61B.

As described above, by providing the third absorption section packings 67A and 67B having a higher heat resistance temperature than the absorption section packings 61A and 61B in the middle of the absorption section packings 61A and 61B, the resin-made absorption section packings 61A and 61B can be disposed to avoid the vicinity of the temperature peak of the exhaust gas G1 (a position where the heat resistance temperature of the absorption section packings 61A and 61B may be exceeded). As a result, the deformation or damage of the absorption section packings 61A and 61B can be more effectively prevented.
(10) According to the tenth aspect, there is provided a method for protecting an absorption section packing 61 in a carbon dioxide capture device 4 including a cooling tower 5 that cools exhaust gas G1, an absorption tower 6 that is configured to absorb carbon dioxide contained in the exhaust gas G1 cooled in the cooling tower 5 into an absorbing liquid to remove the carbon dioxide, and a regeneration tower 7 that separates the carbon dioxide from the absorbing liquid discharged from the absorption tower 6 to regenerate the absorbing liquid, the method includes: a step of, in a case where a temperature of an absorption section packing 61 made of a resin, which brings the absorbing liquid and the exhaust gas into gas-liquid contact, is equal to or higher than a limit temperature corresponding to the heat resistance temperature of the absorption section packing 61, performing control to lower the temperature of the absorption section packing 61.

### EXPLANATION OF REFERENCES

1: plant
100: carbon dioxide capture system
2: dust collection device
3: desulfurization device
4: carbon dioxide capture device
5: cooling tower
50: main body section
50A: exhaust gas introduction flow passage
50B: exhaust gas discharge flow passage
51: cooling tower packing
52: condensed water circulation section
521: condensed water circulation flow passage
522: pump
523: heat exchanger
53: condensed water distribution section
54: cooling section
541: cooling water flow passage
542: cooling water control valve
543: cooling water distribution section
544: second cooling tower packing
545: on-off valve
546: on-off valve
56: cooling tower control unit
6: absorption tower
60: main body section
61: absorption section packing
61A: first absorption section packing
61B: second absorption section packing
63: absorbing liquid distribution section
63A: first absorbing liquid distribution section
63B: second absorbing liquid distribution section
621: rich absorbing liquid line
622: pump
623: heat exchanger
624: heat exchanger
625: absorbing liquid control valve
64: absorption tower washing section
641: washing water circulation flow passage
642: pump
643: heat exchanger
645: chimney tray
65: purified gas discharge flow passage
661: semi-rich absorbing liquid line
662: pump
663: heat exchanger
664: second chimney tray
67, 67A, 67B: third absorption section packing
7: regeneration tower
74: reflux drum
721: lean absorbing liquid line

What is claimed is:

1. A carbon dioxide capture device comprising:
a cooling tower that is configured to cool exhaust gas;
an absorption tower that is configured to absorb carbon dioxide contained in the exhaust gas cooled in the cooling tower into an absorbing liquid to remove the carbon dioxide; and
a regeneration tower that is configured to separate the carbon dioxide from the absorbing liquid discharged from the absorption tower to regenerate the absorbing liquid,
wherein the absorption tower includes:
an absorption section packing made of a resin, which is configured to bring the absorbing liquid and the exhaust gas into gas-liquid contact, and
an absorption tower control unit that is configured to perform control to lower a temperature of the absorption section packing in a case where the temperature of the absorption section packing is equal to or higher than a limit temperature corresponding to a heat resistance temperature of the absorption section packing.

2. The carbon dioxide capture device according to claim 1,
wherein the absorption tower further includes:
a lean absorbing liquid line that supplies the absorbing liquid regenerated in the regeneration tower to the absorption tower; and
a heat exchanger that is provided in the lean absorbing liquid line and configured to cool the absorbing liquid, and
wherein the absorption tower control unit is configured to lower a set temperature of the heat exchanger in the lean absorbing liquid line in a case where the temperature of the absorption section packing is equal to or higher than the limit temperature corresponding to the heat resistance temperature of the absorption section packing.

3. The carbon dioxide capture device according to claim 1,
wherein the absorption tower further includes:
a lean absorbing liquid line that supplies the absorbing liquid regenerated in the regeneration tower to the absorption tower; and
an absorbing liquid control valve that is provided in the lean absorbing liquid line and adjusts a flow rate of the absorbing liquid, and
wherein the absorption tower control unit is configured to increase an opening degree of the absorbing liquid control valve in a case where the temperature of the absorption section packing is equal to or higher than the limit temperature corresponding to the heat resistance temperature of the absorption section packing.

4. The carbon dioxide capture device according to claim 1,
wherein the cooling tower includes:
a condensed water circulation section having a condensed water circulation flow passage that is configured to pump up, by a pump, condensed water stored in a lower portion of the cooling tower and circulate the condensed water to an upper portion of the cooling tower, and a heat exchanger that is configured to cool the condensed water flowing through the condensed water circulation flow passage, and
wherein the absorption tower control unit is configured to lower a set temperature of the heat exchanger of the condensed water circulation flow passage of the cooling tower in a case where the temperature of the absorption section packing is equal to or higher than the limit temperature corresponding to the heat resistance temperature of the absorption section packing.

5. The carbon dioxide capture device according to claim 1,
wherein the absorption tower control unit is configured to end the control of lowering the temperature of the absorption section packing in a case where the temperature of the absorption section packing is lower than the limit temperature.

6. The carbon dioxide capture device according to claim 1,
wherein the carbon dioxide capture device is provided in a plant configured to discharge the exhaust gas, and
the absorption tower control unit is configured to stop an operation of the plant in the case where the temperature of the absorption section packing is equal to or higher than an upper limit temperature higher than the limit temperature.

7. The carbon dioxide capture device according to claim 1,
wherein the absorption tower further includes:
a first absorption section packing which is the absorption section packing,
a second absorption section packing made of a resin, which is provided below the first absorption section packing and is configured to bring the absorbing liquid and the exhaust gas into gas-liquid contact with each other;
a second chimney tray which is provided between the first absorption section packing and the second absorption section packing and stores the absorbing liquid in which carbon dioxide is absorbed in the first absorption section packing;
a semi-rich absorbing liquid line which supplies the absorbing liquid stored in the second chimney tray to the second absorption section packing; and
a heat exchanger which is provided in the semi-rich absorbing liquid line and cools the absorbing liquid, and
wherein the absorption tower control unit is configured to lower a set temperature of the heat exchanger in the semi-rich absorbing liquid line in a case where a temperature of the second absorption section packing is equal to or higher than a limit temperature corresponding to a heat resistance temperature of the second absorption section packing.

8. The carbon dioxide capture device according to claim 1,
wherein the absorption tower further includes a third absorption section packing made of a metal, which is provided to be interposed in the absorption section packing.

9. The carbon dioxide capture device according to claim 7,
wherein the absorption tower further includes a third absorption section packing made of a metal, which is provided to be interposed in at least one of the first absorption section packing or the second absorption section packing.

10. A method for protecting an absorption section packing in a carbon dioxide capture device including a cooling tower that cools exhaust gas, an absorption tower that is configured to absorb carbon dioxide contained in the exhaust gas cooled in the cooling tower into an absorbing liquid to remove the carbon dioxide, and a regeneration tower that separates the carbon dioxide from the absorbing liquid discharged from the absorption tower to regenerate the absorbing liquid, the method comprising:
a step of, in a case where a temperature of an absorption section packing made of a resin, which brings the absorbing liquid and the exhaust gas into gas-liquid contact, is equal to or higher than a limit temperature corresponding to a heat resistance temperature of the absorption section packing, performing control to lower the temperature of the absorption section packing.
